(19) United States
(12) Patent Application Publication
(10) Pub. No.: US 2007/0266407 A1
(43) Pub. Date: Nov. 15, 2007

(54) Digital television receiver and method for processing broadcast signal

(75) Inventor: Hyung Sun Yum, Incheon (KR)

Correspondence Address: MCKENNA LONG & ALDRIDGE LLP, 1900 K STREET, NW, WASHINGTON, DC, 20006, US

(73) Assignee: LG. Electronics, Inc., Seoul (KR)

(21) Appl. No.: 11/798,189

(22) Filed: May 10, 2007

(30) Foreign Application Priority Data
May 12, 2006 (KR) 10-2006-0043105

(51) Int. Cl. H04N 5/445; G06F 13/00; H04N 7/16; G06F 3/00

(52) U.S. Cl. 725/58; 725/135

(57) ABSTRACT

A digital television (DTV) receiver and a method for processing a broadcast signal are disclosed. The method for processing a digital broadcast signal includes: receiving a broadcast signal including at least one sub-event information for constructing an event in an Event Information Table (EIT); and displaying the at least one sub-event information of the event on a screen using the received broadcast signal. A broadcast receiver analyzes schedule information contained in the broadcast signal, and provides a user with event information and the schedule list of the event. Therefore, the user can easily recognize the schedule of a specific event, can precisely select his or her desired schedule, and can establish a viewing reservation function and a recording reservation function for each schedule.

This application claims the benefit of Korean Patent Application No. 10-2006-0043105, filed on May 12, 2006, which is hereby incorporated by reference as if fully set forth herein.

### BACKGROUND OF THE INVENTION

1. Field of the Disclosure

The present invention relates to a digital television (DTV) receiver and a method for processing a broadcast signal.

2. Discussion of the Related Art

Typically, a Program and System Information Protocol (PSIP) is an Advanced Television System Committee (ATSC) standard for terrestrial and cable digital broadcast technologies.

The PSIP transmits broadcast signals encoded by an MPEG-2 system to a broadcast receiver. A digital TV performs parsing of the encoded broadcast signals, and displays a variety of programs.

The PSIP can transmit/receive Audio/Video (A/V) data configured in the form of MPEG-2 video data and AC-3 audio format. The PSIP includes a variety of tables capable of transmitting information of channels of individual broadcast stations and each program of the channel, etc. There are a variety of tables, for example, a Master Guide Table (MGT), a Terrestrial Virtual Channel Table (TVCT), a Cable Virtual Channel Table (CVCT), a System Time Table (STT), a Rating Region Table (RRT), an Event Information Table (EIT), and an Extended Text Table (ETT), etc.

Conventionally, the PSIP can provide users with a variety of information associated with each of numerous events via an Electronic Program Guide (EPG) service, etc.

However, the term “event” of the above-mentioned PSIP is indicative of a broadcast program unit. Namely, the event is a collection of associated program elements that have a common timeline for a defined period.

For example, if there are broadcast programs (i.e., drama1, movie2, and news1), the broadcast programs (i.e., drama1, movie2, and news1) configure a single event.

The EPG is indicative of a program schedule including program and summary data of individual channels.

The EPG serves as an electronic guide equal to a printed television (TV) program guide, and is generally controlled by a remote controller. Besides, the EPG may order a pay-per-view program, may search for programs for each theme or category, and may record video data, etc.

However, the above-mentioned conventional digital broadcast technology has the following disadvantages.

Firstly, the conventional digital broadcast technology transmits start time information and end time information using only event units, such that the user is unable to recognize a detailed schedule of each event.

Secondly, provided the detailed schedule of each event is displayed in the form of general text data, the broadcast receiver of the conventional digital broadcast technology has difficulty in freely controlling the displayed schedule.

### SUMMARY OF THE INVENTION

Accordingly, the present invention is directed to a digital television (DTV) receiver and a method for processing the same that substantially obviate one or more problems due to limitations and disadvantages of the related art.

An object of the present invention is to provide a method for transmitting a broadcast signal associated with an event schedule such that a user can check at least one schedule of a specific event of a Program and System Information Protocol (PSIP), a method for controlling the broadcast signal, and a broadcast receiver for processing the same.

Another object of the present invention is to provide a method for transmitting a broadcast signal associated with the event schedule, such that the user can easily establish a variety of functions (e.g., a reserved recording function, and a reserved viewing function) according to at least one schedule for constructing the specific event in the PSIP, a method for transmitting a broadcast signal associated with the event schedule, a method for controlling the broadcast signal, and a broadcast receiver for processing the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for processing a digital broadcast signal comprising: receiving a broadcast signal including sub-event information for one or more sub-events constructing an event in an Event Information Table (EIT); and parsing the at least one sub-event information from the broadcast signal and displaying the parsed sub-event information.

In another aspect of the present invention, there is provided a digital broadcast receiver comprising: a tuner for receiving a broadcast signal; a demultiplexer for demultiplexing the received broadcast signal; a decoder for parsing the demultiplexed broadcast signal, and detecting a sub-event information for one or more sub-events constructing an event in an Event Information Table (EIT); and an application manager for displaying the parsed sub-event information on a screen.

In yet another aspect of the present invention, there is provided a method for transmitting a digital broadcast signal comprising: inserting sub-event information for one or more sub-events constructing an event in the digital broadcast signal; and transmitting the digital broadcast signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 exemplarily shows a bit stream syntax associated with an Event Information Table (EIT);

FIG. 2 exemplarily shows an event schedule descriptor syntax;

FIG. 3A shows an exemplary definition of a “schedule_type” field value of the event schedule descriptor;

FIG. 3B shows another exemplary definition of a “schedule_type” field value of the event schedule descriptor;

FIG. 4 is a block diagram illustrating a broadcast receiver for receiving/processing an Event Information Table (EIT) and an event schedule descriptor;

FIG. 5 is a flow chart illustrating a method for controlling the broadcast receiver capable of receiving/processing an event information table (EIT) and an event schedule descriptor; and

FIG. 6 shows an exemplary screen image on which an event schedule is displayed by a broadcast receiver.

### DETAILED DESCRIPTION OF THE INVENTION

Reference will now be made in detail to the embodiments of the present disclosure, examples of which are illustrated in the accompanying drawings. Wherever possible, the same reference numbers will be used throughout the drawings to refer to the same or like parts.

For the convenience of description and better understanding of the present invention, the present invention will sequentially describe a method for constructing an EIT syntax, a method for defining a “schedule_type” field value of an event schedule descriptor, a broadcast receiver for receiving/processing the EIT, and a method for controlling the broadcast receiver.

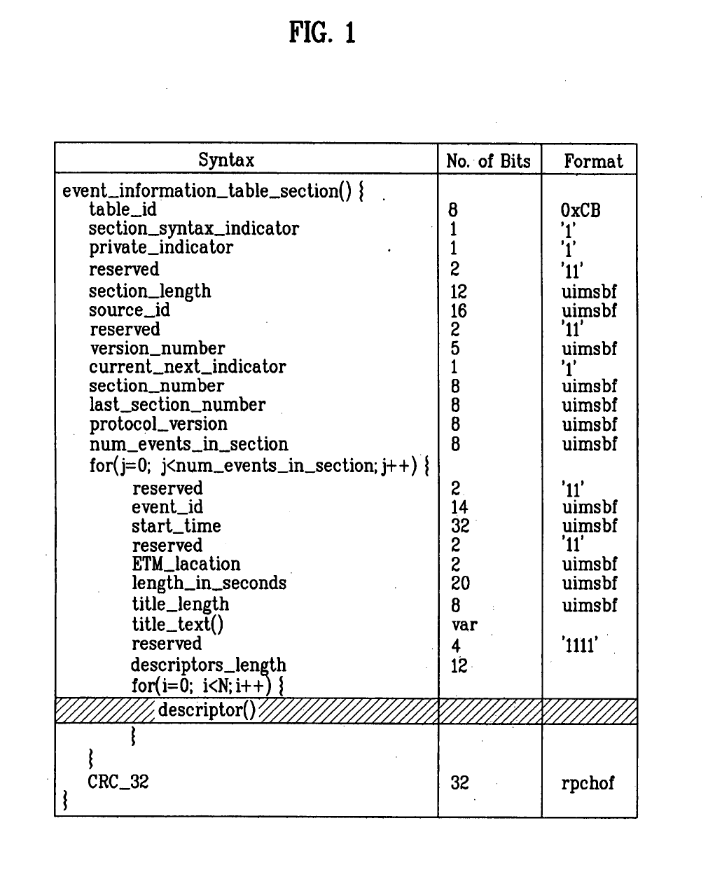

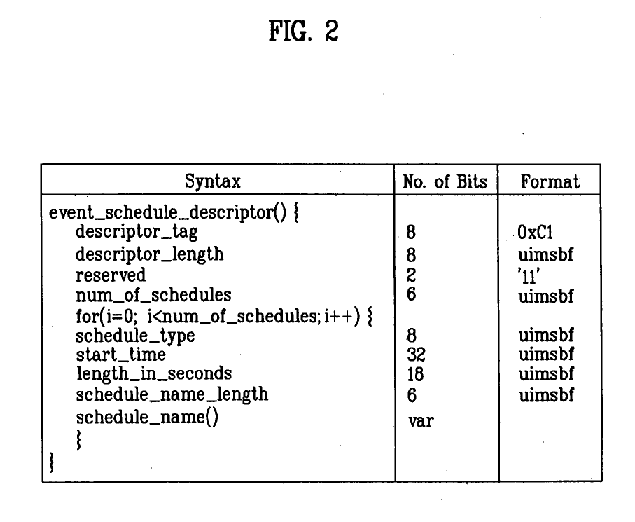

FIG. 1 exemplarily shows a bit stream syntax associated with an Event Information Table (EIT) according to the present invention. FIG. 2 exemplarily shows the event schedule descriptor syntax according to the present invention.

A method for constructing an event information table (EIT) syntax will hereinafter be described with reference to FIGS. 1 and 2.

The Event Information Table (EIT) contains information (titles, start times, etc.) for events on defined virtual channels. An event is, in most cases, a typical TV program. The EIT shall be used to provide information for virtual channels. Up to 128 EITs may be transmitted and each of them is referred to as EIT-k (where k=0, 1, . . . 127). Each EIT-k can have multiple instances, each of which contains information for one virtual channel, and each of which is identified by the combination of “table_id” and “source_id” fields.

As can be seen from FIG. 1, the EIT includes a plurality of fields.

The “table_id” field is an 8-bit field which shall be set to 0xCB, identifying this section as belonging to the Event Information Table.

The “section_syntax_indicator” field is a 1-bit field set to “1”, such that it denotes that the section follows the generic section syntax beyond the section length field.

The “private_indicator” field is a 1-bit field, and is set to the value of “1”.

In association with the disclosure, the most important part is a descriptor defined under the “for-loop” syntax, and other fields other than the descriptor will herein be omitted for the convenience of description.

The disclosure is characterized in that the event schedule descriptor of FIG. 2 is defined in the oblique-lined descriptor of FIG. 1.

As can be seen from FIG. 2, the “descriptor_tag” field includes identification information for allowing the descriptor to identify the event schedule descriptor.

The “descriptor_tag” field may be set to the value of “0xC1”, however, it should be noted that the “0xC1” value is disclosed for only illustrative purposes, and other values may also be used as necessary.

The “descriptor_length” field includes specific information for defining the length from the next field to the last field of the descriptor. For example, the “descriptor_length” field may be defined in byte units.

The “num_of_schedules” field includes specific information for indicating the number of at least one schedule constructing a specific event. For example, the specific event may be identified by the “event_id” field from among virtual-channel events identified by the combination of the “table_id” field and the “source_id” field of the EIT table including the above-mentioned descriptor.

The number of schedules is indicative of the number of sub-events constructing a specific event. For example, provided that a specific event is a news broadcast program, and a total of 15 news themes are contained in the news broadcast program, the number of schedules is set to 15.

The “schedule_type” field includes specific information for defining the type of the above-mentioned individual schedules. The 8 bits may be allocated to the “schedule_type” field. Otherwise, 4 bits may be allocated to the “schedule_type” field and the remaining 4 bits may be used as a “reserved” field. The example for defining the “schedule_type” field value will be described with reference to a second embodiment in detail.

The “start_time” field includes specific information for defining the start time of each schedule. The “length_in_seconds” field includes specific information for defining a duration time of each schedule. This duration time may be defined in units of seconds.

The “schedule_name_length” field includes specific information for defining the length of the name of each schedule. This “schedule_name_length” field may be defined in byte units. The “schedule_name” field includes specific information for defining the name of each schedule.

Therefore, an additional event schedule descriptor is assigned to each event, such that specific information of a single event may also be added to the event.

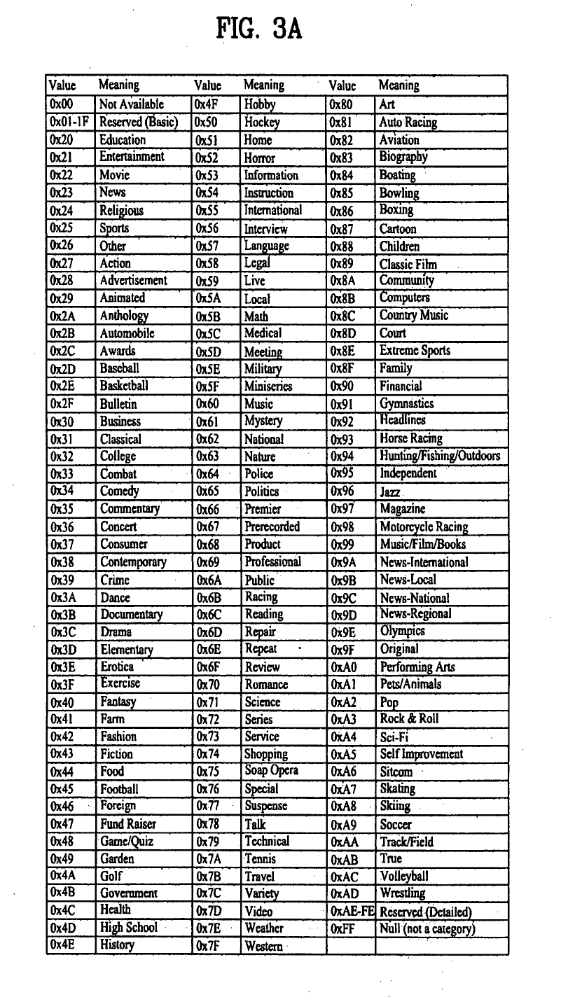

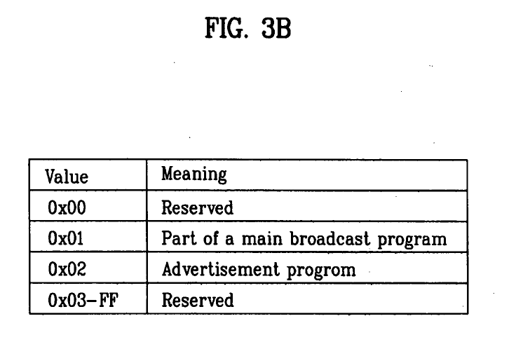

FIG. 3A shows an exemplary definition of a “schedule_type” field value of the event schedule descriptor. FIG. 3B shows another exemplary definition of a “schedule_type” field value of the event schedule descriptor.

Two embodiments for defining the value of the “schedule_type” field according to the present disclosure will hereinafter be described in detail.

The “schedule_type” field of FIG. 2 includes specific information for defining the type of each schedule constructing a single event.

A first embodiment is shown in FIG. 3A, and it defines detailed information (e.g., content type) of the schedule type in the “schedule_type” field. For example, provided that the news broadcast program event exists, and several schedules for constructing the event (each news theme) exist, the first embodiment can represent detailed information of the above-mentioned schedules. The above-mentioned information may be defined by at least one value contained in the “schedule_type” field.

For example, in the case where the field has the value “0x20”, “0x44”, and “0x71” respectively, a broadcast receiver can pre-recognize that a specific schedule for constructing an event of the broadcast program is an educational news theme (i.e., the “schedule_type” field has the value “0x20” in FIG. 3A), another schedule is a food news theme (i.e., the “schedule_type” field has the value “0x44” in FIG. 3A), and a still another schedule is a science news theme (i.e., the “schedule_type” field has the value “0x71” in FIG. 3A).

A second embodiment is shown in FIG. 3B, and it defines schedule identification (ID) information in the “schedule_type” field, such that it can determine whether the above-mentioned schedule is contained in the main broadcast program or is the advertisement broadcast program.

The above-mentioned second embodiment has an advantage in that it is highly advantageous to a broadcast system for intermittently transmitting advertisement data during a single broadcast program. Also, the second embodiment can implement the present disclosure using a small number of memories as compared to the first embodiment.

For example, if it is determined that a specific schedule is partially contained in a normal main broadcast program, the “schedule_type” field is set to the value “0x01” as shown in FIG. 3B. If it is determined that a specific schedule is the advertisement broadcast program, the “schedule_type” field is set to the value “0x02” as shown in FIG. 3B. Therefore, the second embodiment of the present disclosure can easily filter intermediate advertisement data intermittently inserted into the main broadcast program.

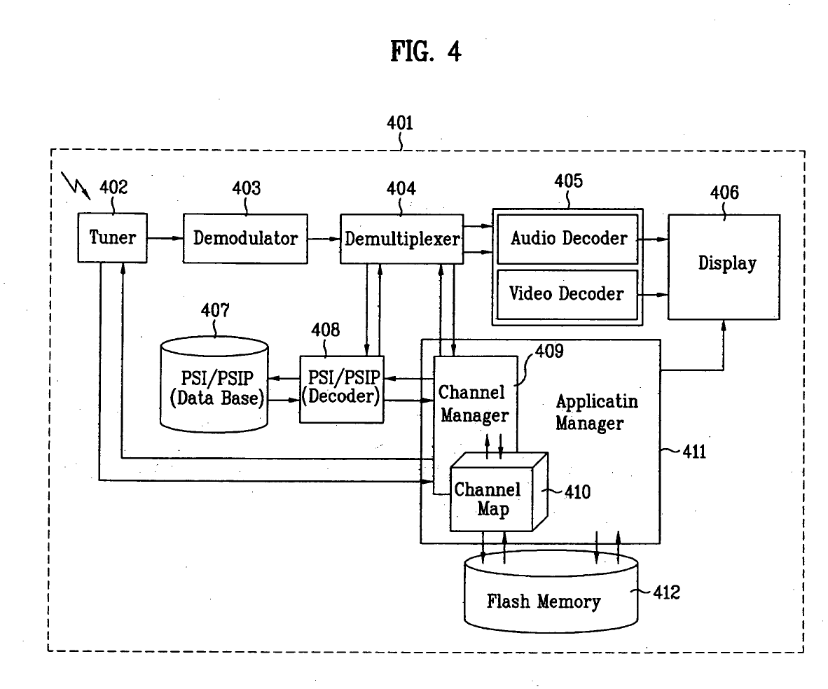

FIG. 4 is a block diagram illustrating a broadcast receiver for receiving/processing an Event Information Table (EIT) and an event schedule descriptor. The broadcast receiver for receiving/processing the EIT will hereinafter be described with reference to FIGS. 4 and 1˜3B.

Referring to FIG. 4, the broadcast receiver 401 includes a tuner 402, a demodulator 403, a demultiplexer 404, an A/V decoder 405, a display 406, a PSI/PSIP database 407, a PSI/PSIP decoder 408, a channel manager 409, a channel map 410, an application manager 411, and a flash memory 412, etc.

The broadcast receiver 401 may be set to a digital TV (DTV) capable of receiving digital broadcast data.

The tuner 402 can receive a digital broadcast signal including the PSI/PSIP (Program Specific Information/Program and System Information Protocol) table.

Particularly, the PSI/PSIP table includes the EIT (Event Information Table).

The tuner 402 can be controlled by the channel manager 409. The tuner 402 transmits the received digital broadcast signal to the channel manager 409.

The demodulator 403 demodulates the signal tuned by the tuner 402 into a VSB/EVSB (Vestigial Side Band/Enhanced Vestigial Side Band) signal.

The demultiplexer 404 demultiplexes the signal demodulated by the demodulator 403 into audio data, video data, and PSI/PSIP table data.

The demultiplexing of the audio and video data can be controlled by the channel manager 409. The demultiplexing of the PSI/PSIP table data can be controlled by the PSI/PSIP decoder 408.

The demultiplexed PSI/PSIP table is transmitted to the PSI/PSIP decoder 408. The demultiplexed audio and video data is transmitted to the A/V decoder 405. The A/V decoder 405 decodes the received audio and video data.

The PSI/PSIP decoder 408 performs parsing of the PSI/PSIP section, reads the remaining actual section data which has not been section-filtered by the demultiplexer 404, and records the read data in the PSI/PSIP database 407.

The channel manager 409 requests a channel-associated information table by referring to the channel map 410, and receives the response to the request.

In this case, the PSI/PSIP decoder 408 controls the demultiplexing of the channel-associated information table, and transmits the A/V PID (Packet ID) list to the channel manager 409.

The channel manager 409 controls the demultiplexer 404 using the received A/V PID list, such that audio/video data is transmitted to the A/V decoder 405.

The application manager 411 controls a Graphical User Interface (GUI) for displaying status information of the broadcast receiver system on the OSD (On Screen Display).

Particularly, according to the present disclosure, the demultiplexer 404 demultiplexes the EIT, and transmits the demultiplexed result to the PSI/PSIP decoder 408.

The EIT (Event Information Table) according to the present disclosure is equal to those of FIGS. 1˜2. In this case, the PSI/PSIP decoder 408 detects the EIT and acquires schedule information of a specific event.

The application manager 411 controls the display 406 by referring to the above-mentioned information, can display the schedule information contained in the specific event, and at the same time can also output the same schedule information in the form of audio data. Otherwise, the application manager 411 can output the above-mentioned schedule information in the form of only the audio data other than the video data.

In the meantime, if the user who has noticed the schedule information establishes a viewing reservation function for only the specific schedule, the channel manager 409 controls the tuner 402 at a specific time, and the application manager 409 allows specific schedule data desired by the user to be displayed on the display 406.

If the user who has noticed the schedule information establishes a recording reservation function for only a specific schedule, the channel manager 409 controls the tuner 402 at a specific time, and the application manager 409 or the PVR (Personal Video Recorder) controller (not shown) controls specific schedule data desired by the user to be stored in a Hard Disc Drive (HDD).

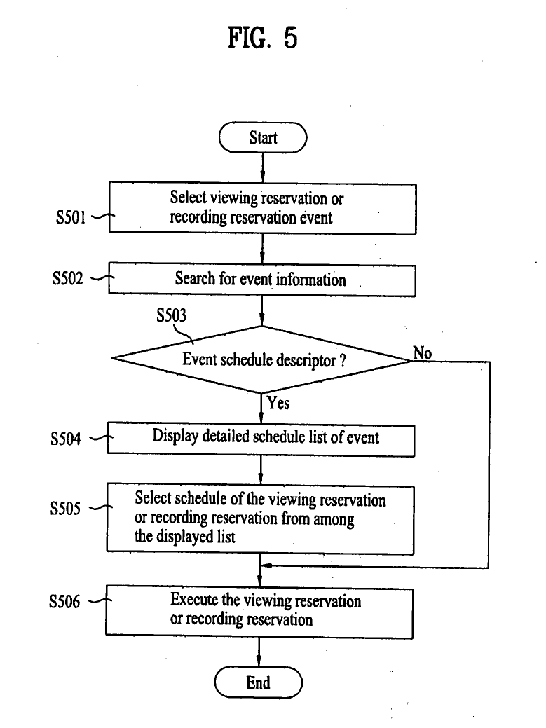

FIG. 5 is a flow chart illustrating a method for controlling the broadcast receiver capable of receiving/processing an event information table (EIT) and an event schedule descriptor.

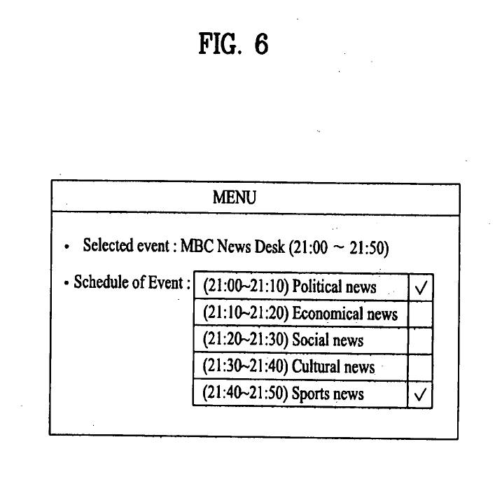

FIG. 6 shows an exemplary screen image on which an event schedule is displayed by a broadcast receiver.

A method for controlling the broadcast receiver according to the present disclosure will hereinafter be described with reference to FIGS. 5, 6, and 1˜4.

Referring to FIG. 5, the broadcast receiver selects a specific event for the viewing reservation function or the recording reservation function by referring to the EPG at step S501. The broadcast receiver searches for information of the selected specific event from PSIP data at step S502. In more detail, The PSIP data is indicative of the EIT. The exemplary EIT is shown in FIGS. 1˜2.

The broadcast receiver determines the presence or absence of an event schedule descriptor in the above-mentioned specific event information at step S503.

If it is determined that there is no event schedule descriptor at step S503, the broadcast receiver goes to step S506. Otherwise, if the presence of the event schedule descriptor is determined at step S503, the broadcast receiver displays a detailed schedule list on the display at step S504.

For example, the broadcast receiver can show the description of each list constructing the selected event, and at the same time can also display the play time of the list, as shown in FIG. 6.

The user additionally selects a specific schedule for the viewing reservation or the recording reservation from among the displayed list at step S505.

For example, if the selected specific schedule is displayed as shown in FIG. 6, the broadcast receiver displays a specific mark on the right side of the schedule title or name, such that it can distinguish the selected schedule from other schedules.

If the event or schedule for either the viewing reservation or the recording reservation is completely terminated, the broadcast receiver executes the viewing reservation function or the recording reservation function at the beginning of the selected schedule at step S506.

It should be noted that most terminology disclosed in the present disclosure is defined in consideration of functions of the present disclosure, and can be differently determined according to intention of those skilled in the art or usual practices. Therefore, it is preferable that the above-mentioned terminology be understood on the basis of all contents disclosed in the present disclosure. Other implementations are within the scope of the following claims. The details of one or more implementations are set forth in the accompanying drawings and the description below. Other features will be apparent from the description and drawings, and from the claims.

As apparent from the above description, a method for transmitting a broadcast signal associated with an event schedule of the PSIP, a method for controlling the broadcast signal, and a broadcast receiver for processing the above-mentioned methods have the following effects.

Firstly, the present disclosure can allow a user to easily check at least one schedule of a specific event.

Secondly, the present disclosure can allow the user to easily establish the viewing reservation or the recording reservation according to individual schedules.

In addition, the present disclosure is superior to a conventional Extended Text Table (ETT) capable of providing only text data. For example, in the case of the news event in which a single event includes a plurality of schedules, the EIT descriptor according to the present disclosure is highly advantageous to the conventional art.

If the news broadcast program broadcast a plurality of news themes, the present invention can transmit information of the individual news themes via the event schedule descriptor to the broadcast receiver. In this case, the user can check which one of news data from among the news broadcast program will be broadcast using the above-mentioned descriptor. Therefore, the user can more precisely select his or her preferred broadcast program.

It will be apparent to those skilled in the art that various modifications and variations can be made in the present disclosure without departing from the spirit or scope of the inventions. Thus, it is intended that the present disclosure covers the modifications and variations of this invention provided they come within the scope of the appended claims and their equivalents.

What is claimed is:

1. A method for processing a digital broadcast signal comprising:
receiving a broadcast signal including sub-event information for one or more sub-events constructing an event in an Event Information Table (EIT); and
parsing the at least one sub-event information from the broadcast signal and displaying the parsed sub-event information.

2. The method according to claim 1, wherein the EIT includes a table identification field and a source identification field identifying a virtual channel.

3. The method according to claim 1, wherein the EIT includes an event identification field identifying the section information event from among events of a corresponding virtual channel.

4. The method according to claim 1, further comprising:
establishing a viewing reservation function for each sub-event using the displayed sub-event information; and
performing the viewing reservation function for each sub-event according to the established function.

5. The method according to claim 1, wherein the at least one sub-event information of the event is defined by a descriptor of the event information table (EIT).

6. The method according to claim 1, wherein each sub-event information includes a start time of the sub-event and a broadcast duration time of the sub-event.

7. The method according to claim 1, wherein each sub-event information includes name or title information of the sub-event.

8. The method according to claim 1, wherein each sub-event information includes type information of the sub-event.

9. The method according to claim 8, wherein the sub-event type information is an identifier for identifying a content type of the sub-event.

10. The method according to claim 8, wherein the sub-event type information is an identifier for determining whether the sub-event is a part of a main broadcast program, or is an advertisement broadcast program.

11. A digital broadcast receiver comprising:
a tuner for receiving a broadcast signal;
a demultiplexer for demultiplexing the received broadcast signal;
a decoder for parsing the demultiplexed broadcast signal, and detecting a sub-event information for one or more sub-events constructing an event in an Event Information Table (EIT); and
an application manager for displaying the parsed sub-event information on a screen.

12. The digital broadcast receiver according to claim 11, wherein the application manager establishes a viewing reservation function for each sub-event using the displayed sub-event information, and performs the viewing reservation function according to the established information.

13. The digital broadcast receiver according to claim 11, wherein the at least one sub-event information of the event is defined by a descriptor of the event information table (EIT).

14. The digital broadcast receiver according to claim 11, wherein each sub-event information includes a start time of the sub-event and a broadcast duration time of the sub-event.

15. The digital broadcast receiver according to claim 11, wherein each sub-event information includes name or title information of the sub-event.

16. The digital broadcast receiver according to claim 11, wherein each sub-event information includes type information of the sub-event.

17. The digital broadcast receiver according to claim 16, wherein the sub-event type information is an identifier for identifying content type of the sub-event.

18. The digital broadcast receiver according to claim 16, wherein the sub-event type information is an identifier for determining whether the sub-event is a part of a main broadcast program, or is an advertisement broadcast program.

19. A method for transmitting a digital broadcast signal comprising:
inserting sub-event information for one or more sub-events constructing an event in the digital broadcast signal; and
transmitting the digital broadcast signal.

20. The method according to claim 19, wherein the at least one sub-event information of the event is contained in a descriptor of an event information table (EIT).

21. The method according to claim 19, wherein each sub-event information includes a start time of the sub-event and a broadcast duration time of the sub-event.

22. The method according to claim 19, wherein each sub-event information includes name or title information of the sub-event.

23. The method according to claim 19, wherein each sub-event information includes type information of the sub-event.
